(19) United States
(12) Patent Application Publication
(10) Pub. No.: US 2010/0029359 A1
(43) Pub. Date: Feb. 4, 2010

(54) Gaming machine and system with external outcome generator

(76) Inventor: Joseph W. Cole, North Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/220,937

(22) Filed: Jul. 30, 2008

(51) Int. Cl. A63F 9/24; A63F 13/00

(52) U.S. Cl. 463/16

(57) ABSTRACT

A gaming device and gaming system utilize an external outcome generator for use in determining game outcomes. The external outcome generator may comprise an ever-changing, uncontrollable, public source of data, such as the stock market average. Information, such as numerical values, are obtained from the external outcome generator or source and used in determining game outcomes. In one embodiment, numerical data is utilized to determine secondary game information, such as video poker card data or video slot symbols or outcomes.

### FIELD OF THE INVENTION

The present invention relates to gaming machines and gaming system in which game outcomes are determined by an external random outcome generator.

### BACKGROUND OF THE INVENTION

Gaming activities are well known and come in a variety of forms. Some games are skill or partially skill based, such as pinball, skee-ball and similar games. Other games involve little or no skill. For example, mechanical slot machines were developed long ago. These machines utilized rotating reels to determine game outcomes. The outcome of each game is determined purely randomly, without any player input or skill, based upon the random stopping position of the reels.

Over time, electronic gaming devices were developed. The advent of random number generators permitted game designers to randomly generate game results which could then be displayed. For example, U.S. Pat. No. 4,448,419 discloses a gaming machine having a random number generator that selects reel stopping positions. Controllers are provided for stopping slot reels based upon the stopping positions to display the randomly selected outcome.

One problem with the design of these games is that a random number generator has to be associated with each gaming machine. This increases the cost and complexity of each machine. Further, game manufacturers are currently investigating “server” based games in which game information is provided to a plurality of gaming machines by one or more game servers. In such systems, the use of a random number generator at each gaming machine increases the complexity of the system.

### SUMMARY OF THE INVENTION

The invention comprises a gaming machine and gaming system including one or more gaming machines. In accordance with the invention, a gaming machine and system utilizes an external outcome generator or source for determining game outcomes. The external outcome generator or source may comprise an external source of information which can be used to determine game outcomes.

In one embodiment, the external source is publicly accessible and can not be controlled or manipulated by a player, game manufacturer, casino or the like, and preferably provides a continuously changing output. The external source may comprise a stock market or values associated therewith, such as the NASDAQ composite or the Dow Jones Industrial Average.

In one embodiment, a gaming machine utilizes the external outcome information directly, wherein a player may wager against the outcome information. For example, a player may wager against values of the stock market, such as whether the stock market will reach a certain value at a particular time. In other embodiments, the external outcome information maybe utilized to generate secondary game information, such as video poker card or hand data, video slot symbols or reels stops or the like.

The external outcome information may comprise numerical values, letters or other information. The external outcome information may be obtained directly, such as from the source thereof, or from a secondary source, such as a stock market reporting service.

In one embodiment, a gaming network server may obtain external outcome information. The server may utilize the information in generating game information. The server may transmit the game information to individual gaming machines for presentation of games at the gaming machines.

In accordance with the invention, a gaming machine and system obtains game outcome information from an external source, rather than a gaming device or gaming system dedicated internal random number generator or similar game determinator.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a gaming machine in accordance with one embodiment of the invention;

FIG. 2 is a diagram of one embodiment of a system of the invention; and

FIG. 3 is a diagram of another embodiment of a system of the invention.

### DETAILED DESCRIPTION OF THE INVENTION

The invention includes gaming machines or devices, systems including one or more gaming machines, and methods of playing a game. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises gaming machines configured to present a game and one or more systems including gaming machines. In a preferred embodiment, the invention is a gaming machine and system utilizing an external source or event as an outcome determinant.

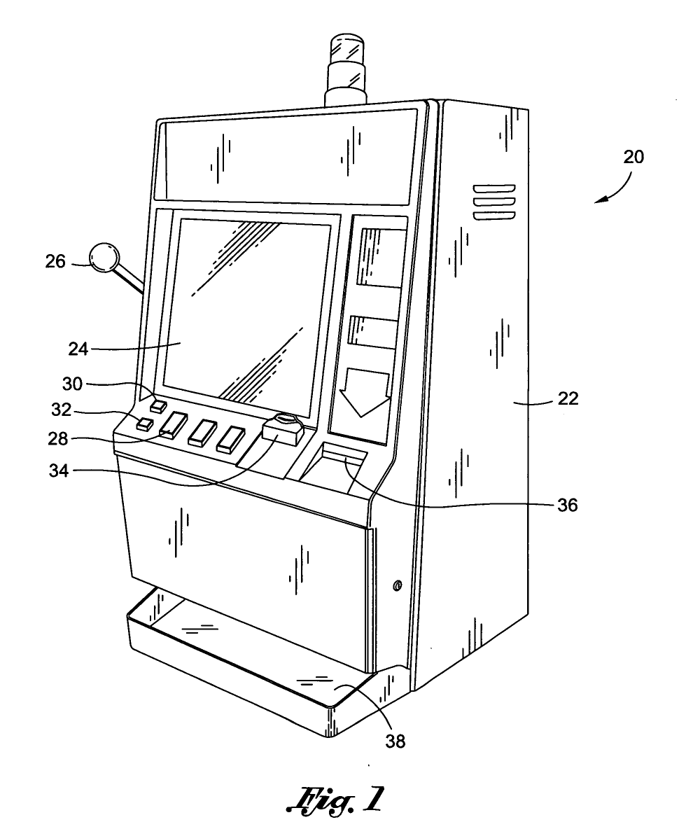

The invention has particular relevance to a gaming machine, though the configuration of the invention may be used for other purposes and in other environments. FIG. 1 illustrates one embodiment of a gaming device 20 to which the invention has relevance. The gaming machine or device 20 is, either alone or in combination with other devices, preferably configured to present a game, such as a game of the invention.

In one embodiment, the gaming machine 20 has a housing 20. It will be appreciated that the housing 22 may have a variety of shapes and configurations. For example, the gaming machine 20 may be configured as an “upright” (as illustrated), “bar-top” or “slant” style gaming machine, which configurations are well known in the industry.

As illustrated, the gaming machine 20 includes means for displaying symbols or indicia utilized in the play or presentation of a game. In a preferred embodiment, the gaming machine 20 includes at least one video display 24. In a preferred embodiment, the video display 24 is utilized to present game information. This game information may comprise text or static or moving images or the like. The game information may include intermediate and/or game outcome information and may pertain to various games now known or later developed. For example, the game information may relate to a game of video poker and include an initial set of dealt cards, one or more replacement cards, and cards representing the finalized poker hand.

Of course, the gaming machine 20 might have other means for displaying game information, including multiple displays and/or physical reels or other display devices. In one embodiment, the gaming machine may include a plurality of physical reels, wherein the various combinations of indicia displayed by the reels have significance to or relate to the outcome of a game presented at the machine 20. Means may be provided for rotating the reels. In one or more embodiments, the means may comprise a mechanical linkage associated with a spin or “start” arm 26, with movement of the spin arm (a “pull”) by a user causing the reels to spin. In one embodiment, an electronically controlled mechanism is arranged to rotate and stop each reel. Such mechanisms are well known to those of skill in the art. In this arrangement, actuation of the spin arm 26 or depression of a spin button causes a controller (not shown) to signal the activation of the spin mechanism associated with one or more of the reels. Preferably, the controller is arranged to either turn off the signal to the device(s) effecting the rotation of each or all of the reels, or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds.

The gaming machine 20 preferably includes one or more player inputs which permit the player to interact with the gaming machine 20. In the embodiment illustrated, the gaming machine 20 includes a plurality of push-buttons. As described above, one such button may comprise a “spin” button 28. As also illustrated, buttons or similar input devices may include a “bet one” button 30, a “bet max” button 32, and the like.

A wide variety of other inputs may be provided, varying both in form and function. For example, in one embodiment, one input may comprise a “touch screen” type display. Other inputs, such as rotatable arms, joysticks, keyboards or keypads, or other inputs may be provided. Each input preferably provides input, such as by way of an electrical signal, to the gaming controller or other game content generating device. In that manner, game play is interactive.

In one embodiment, the gaming machine 20 is configured to present a game only upon a player placing a bet, wager, or other payment. Thus, the gaming machine 20 may include means for accepting value, and preferably, monetary value. As illustrated, the gaming machine 20 may include a coin acceptor 34. The coin acceptor may be configured to accept coins of one or more denominations. A coin sorter, coin hopper and other coin holding and processing devices may be located in the housing 22 of the gaming machine 20.

The gaming machine 20 may also or alternatively include a bill validator 36. The bill validator may be configured to accept paper money of one or more denominations. A bill stacker and other bill processing and storage devices may be located in the housing 22 of the gaming machine 20.

The gaming machine 20 may also or alternatively include a ticket reader, smart card, credit card or other media acceptor/reader. Such devices may be utilized to obtain information regarding value, such as credit card account information or bar-coded ticket value.

When value is provided to the gaming machine 20, the gaming machine 20 may be configured to display information regarding the provided value, such as in the form of “credit” information. This information may be displayed, for example, on a display of the gaming machine or one associated therewith. The player may utilize inputs to place a wager, bet or provide payment to play a game. For example, a player may depress the “bet” button 30 to bet or wager one or more credits.

In one embodiment, the gaming machine 20 is configured to award winnings for winning outcomes of games played. The winnings may be paid or provided to the player in a variety of manners. In one embodiment, awards may be indicated in the form of credits. Thus, when a player wins, the total number of credits belonging to them is increased, and the increased amount may be displayed to the player. The player may utilize the awarded credits to play future games.

In another embodiment, the player may be awarded money, or may convert credits to money. As illustrated, the gaming machine 20 may include a coin tray 38 into which coins may be dispensed. The coins may represent a specific award. Alternatively, the player may utilize a “cash out” button or input (not shown),and be paid the value of their credits in the form of coins.

Other forms of payment may be provided, such as by issuance of a ticket which represents value. As illustrated, the gaming machine 20 includes a ticket printer (not shown) for printing and dispensing a medium bearing information regarding value.

Non-monetary prizes may also be awarded. For example, credits maybe redeemed for prizes or a ticket or tickets may be redeemed for specific prizes or general prizes. In other embodiments, game play may be for entertainment purposes only and no prize or award may be won or awarded. In one embodiment, a player may win points which the player can accrue and use, such as for free game play. In another embodiment, no payment need be provided. For example, the game may be played for recreational purposes only. In other embodiments, points may be awarded, the points having no “value,” except to provide the player an indication of the level of success of play of the game. Such a level of points may be compared, for example, to the level of points achieved by other players.

Preferably, means are provided for controlling the operation of the gaming machine 20, such as for providing information to the game display 24. In one embodiment, that means comprises a gaming controller. The gaming controller may be configured to track game credits (including value provided to the gaming machine and wagers or bets placed) and present game information (such as via the game display 24 or reels or the like). In one embodiment, a gaming controller includes a processor and a memory. The memory stores software which is executed by the processor. In one embodiment, the gaming controller is located inside of the housing 22 of the gaming machine 20.

In another embodiment, the operation of the gaming machine 20 may be controlled in whole or in part from a remote location, such as a remote server. For example, game data may be generated remotely and be transmitted to the gaming machine 20 for display. The game data may then be downloaded to the gaming machine 20 via a wired or wireless communication link. Such a communication link may be wired or wireless or combinations thereof. Communications may be effected using a variety of hardware and software, and in accordance with a number of standards, such as IEEE-1394, IEEE802.xx or the like.

In one or more embodiments, the outcome of one or more events presented at the gaming machine, such as individual games, bonus events or the like, are randomly determined. For example, relative to a game of video poker, the select of particular cards which are used in the game may be determined randomly. In the game of video or mechanical slots, symbols or reel positions representing the outcome of the game may be randomly determined.

In a preferred embodiment, an external outcome generator or source is utilized to determine gaming machine outcomes. Preferably, this external outcome generator is an existing public source of outcomes or events, and not a source or generator which is unique to the gaming machine and/or a gaming system with which the gaming machine is associated, and not one that the game manufacturer, casino or any other entity associated with the game has control over.

In one embodiment, the external outcome generator may comprise one or more public sources of information. Preferably, the source is not and can not be controlled or substantially manipulated by one entity, and provides a generally continuously changing outcome, whereby the outcomes or events of such a source are essentially random. As one example, the external outcome generator might comprise stock market average information, such as the New York Stock Exchange (NYSE) Dow Jones Industrials Average. As another example, the external outcome generator might comprise the NASDAQ composite. Other source of information might be utilized.

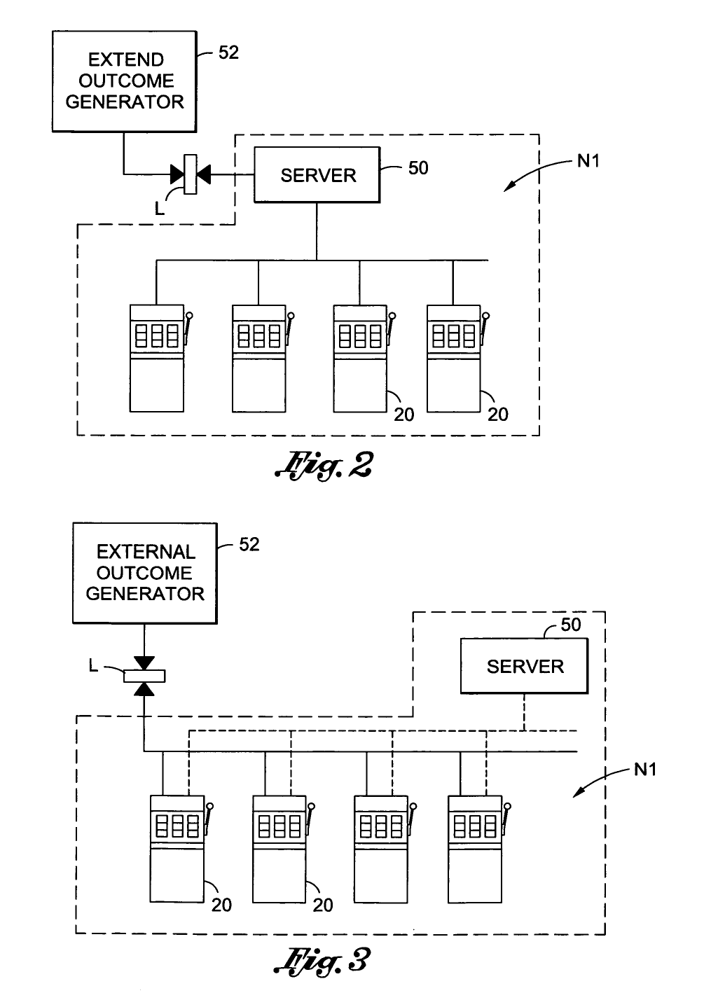

FIG. 2 illustrates one exemplary implementation of the invention. As illustrated, one or more gaming machines or devices 20 are associated with at least one server 50. The server 50 is configured to provide game information, such as game outcome information, to the one or more gaming machines 20. In one embodiment, the gaming machines 20 and server 50 are part of a gaming network N1. Such a network may be associated with a particular casino or other gaming environment, or may be a larger area network, such as one spanning or including more than one casino.

In a preferred embodiment, the server 50 is configured to receive information from an external outcome generator 52 for use in determining game outcomes. As illustrated, the external outcome generator 52 is not part of the gaming network N1. The external outcome generator 52 may be part of an independent or separate network. In one embodiment, the server 50 receives information from the external outcome generator 52 via a link L. This link may comprise a communication link between the gaming network N1 and a network of the external outcome generator 52, it might comprise one or more intermediate networks such as, but not limited to, the Internet. The link L may include a firewall or other controlled access.

As one example, the server 50 may connect to the New York Stock Exchange's proprietary network via an interface. This interface may include various secure communication protocols. In this manner, the server 50 may receive Dow Jones Industrial Average information in relative real-time, directly from the NYSE. In other embodiments, the server 50 might obtain that information indirectly, such as by linking to a source which reports the Dow Jones Industrial Average in near real-time via one or more networks, such as the Internet. Of course, the various communication links may be wired, wireless or combinations thereof.

In one example of game play in accordance with the system illustrated in FIG. 2, a player may seek to play a game at a particular gaming machine 20. When a player places a wager at the gaming machine 20, the gaming machine 20 may send a request to the server 50 for a game outcome. The server 50 may poll or otherwise be provided with external game outcome information from the external outcome generator or source 52. This information may comprise a series of numbers. For example, the numbers might comprise the Dow Jones Industrial Average for the particular moment at which the server 50 takes the poll. The average might be, for example, 11024. This number, or a part thereof, may be used by the server 50 to determine the game outcome. For example, the numbers 1, 1, 0, 2 and 4 might represent card values for the first five cards to be dealt to a player in a game of video poker. Alternatively, the number 11024 might be indexed to a particular 5 card hand to be dealt in the game of video poker. In any event, the external outcome generator provide information, such as numbers or the like, which is used to determine the outcome of a game or a part of a game. In this embodiment, the server 50 may then transmit the game outcome information to the gaming machine 20. The game outcome information might first be converted to particular information to be displayed by the gaming machine (such as images of particular cards or the like), or the information might be transmitted for use by the gaming machine controller (for example, the outcome 11024 might be transmitted directly to the gaming machine controller, which then utilize the information to display the outcome).

FIG. 3 illustrates another embodiment of the invention. In this embodiment, one or more gaming machines 20 are configured to obtain game outcome information directly from an external outcome generator or source 52. In this configuration, each gaming machine 20 can communicate with the external outcome generator 52, rather than by communicating through a game server. Of course, the gaming machines 20 may still communicate with one or more servers 50 for other purposes. In this configuration, the one or more gaming machines 20 and/or server 50 may still be associated with a gaming network N1. The gaming machines 20 may communicate with the external outcome generator 52 via a link L, such as detailed above.

In this configuration, each gaming machine 20 can directly seek game outcome information from the external source, rather than via the server 50. Of course, other embodiments of gaming devices and systems wherein external outcome information is obtained and utilized may be implemented.

In one embodiment, the external outcome information may be “converted” to game information. For example, as indicated above, numeric values may be converted to card data, slot symbols or reel stops or the like. In other embodiments, the information generated or provided by the external outcome generator may be utilized in the direct play of the game. For example, a gaming machine may offer a game in which a player attempts to wager against values or information generated by the external outcome generator or source. In one embodiment, relative to the Dow Jones Industrial Average, a player might be permitted to wager whether the average will reach a particular value at a particular time or over a range of times, or span a range over a range of time. A player might wager that the average will reach 12,200 during a period of game play. In such event, the direct outcome of the game is determined with reference to the external outcome generator or source.

Of course, in such embodiments, a wide range of external sources might be utilized in direct game play or for use in presenting secondary game information (i.e. cards, slot symbols or the like). For example, other sources of external information which might be utilized might comprise the Nikkei or other stock market indices, the price of certain commodities in the market, such as the price of gold, silver or crude oil, bond rates, interest rates or the like. In some embodiments, the external outcome generator or source may generate numeric values. However, the external outcome generator or source might generate other information such as letters, words or the like.

The invention has numerous advantages. First, a gaming device and system can provide for random or “uncontrolled” game outcomes without the need for its own random number generators. In accordance with the invention, an entire gaming system can utilize a single external outcome source.

Another advantage of the invention is that players can confirm that that game outcomes are truly random and not controlled or manipulated, such as by the game manufacturer or casino. For example, if a player plays a game against the Dow Jones Industrial Average, the player can confirm the activity at the NYSE independently, thus confirming if their game outcome was correctly indicated by the gaming machine.

In addition, gaming regulators or similar governing entities may also easily confirm game outcomes. Currently, gaming regulators must carefully scrutinize random number generators placed in gaming machines to ensure they are not corrupt or are not tampered with after they are installed (and during use of the machine). In addition, in the event of large jackpot awards, significant effort may be required to ensure that the jackpot was properly awarded via normal operation of the random number generator. In accordance with the present invention, a gaming machine no longer needs a dedicated random number generator. This avoids the time and effort needed to create such and obtain approval of such from gaming regulators. Second, there is no risk of the random number generator being tampered with, lessening the complexities and costs associated with maintaining security at the gaming machine. Lastly, gaming regulators can easily verify game wins with reference to the external outcome information, since such information is readily available publicly and is likely tracked through multiple sources (and is thus not unique to a particular gaming machine or a particular device at the gaming machine.)

The use of an external outcome generator or source also allows for a wider range of games to be played. In particular, the external source can be used for direct wagering, or can be used to present secondary game information such as video poker, slot or other types of games.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming system comprising:
at least one game server configured to generate game information based upon external outcome information;
a communication link between said server and an external outcome source operable at one or more times to provide to said server said external outcome information; and
at least one gaming machine configured to accept a wager, present a wagering game utilizing, at least in part, game information provided by said server, and provide an award for at least a winning outcome of said wagering game.

2. The gaming system in accordance with claim 1 wherein said external outcome source comprises a source of stock market average data.

3. The gaming system in accordance with claim 1 wherein said communication link comprises a link between said gaming system and the Internet.

4. The gaming system in accordance with claim 1 wherein said game information is determined based upon numerical values comprising said external outcome information.

5. The gaming system in accordance with claim 1 wherein said game information comprises one or more game outcomes.

6. The gaming system in accordance with claim 1 wherein said wagering game comprises a game of poker or slots.

7. The gaming system in accordance with claim 1 wherein said wagering game comprises wagering upon events reported by said external outcome source.

8. A gaming device comprising:
a housing;
a gaming controller located in said housing;
at least one display device controlled by said gaming controller and configured to display wagering game information; and
at least one communication link between said gaming controller and an external outcome generator;
wherein said gaming controller is configured to generate wagering game information based upon external outcome information received from said external outcome generator via said at least one communication link.

9. The gaming device in accordance with claim 8 wherein said external outcome information comprises stock market data.

10. The gaming device in accordance with claim 8 wherein said external outcome information comprises the Dow Jones Industrial Average at a particular point in time.

11. The gaming device in accordance with claim 8 wherein said external outcome information comprises numerical data from a publicly accessible, but uncontrollable, source.

12. The gaming device in accordance with claim 8 wherein said communication link comprises a link between a gaming network with which said gaming device is associated and the Internet.

13. The gaming device in accordance with claim 8 wherein said wagering game information comprises slot or poker game information.

14. The gaming device in accordance with claim 8 wherein said wagering game information comprises a game in which a player wagers against said external outcome information.
